(19) United States
(12) Patent Application Publication
(10) Pub. No.: US 2003/0019881 A1
(43) Pub. Date: Jan. 30, 2003

(54) Assistance tray for manual distribution used in medicine sharing and packing device

(76) Inventor: June Ho Kim, Daegu (KR)

Correspondence Address: JACOBSON HOLMAN PLLC, 400 SEVENTH STREET N.W., SUITE 600, WASHINGTON, DC, 20004, US

(21) Appl. No.: 09/964,350

(22) Filed: Sep. 28, 2001

(30) Foreign Application Priority Data
Jul. 28, 2001 (KR) 2001-0022947

(51) Int. Cl. B65H 1/00; G07F 11/00; B65G 59/00

(52) U.S. Cl. 221/92

(57) ABSTRACT

An assistance tray for manual distribution used in medicine sharing and packing device with a disk-type tray for manual distribution of pills mounted in the front side comprises largely an assistance tray body at the rim portion of which a plurality of auxiliary pill containing portions as many as a plurality of pill containing portions formed at the rim of the upper surface of a disk-type tray for manual distribution are formed and on both sides of which handle portions are formed in the perforated state, and an opening/closing plate which is mounted on the lower surface of the assistance tray body so as to be rotated, at the rim portion of which holes as many as the auxiliary pill containing portions of the assistance tray body are formed, and on one side of which a control handle portion is formed in the protruding state, thereby opening the bottom of the auxiliary pill containing portions of the assistance tray body and accordingly enabling pills distributed to each auxiliary pill containing portion of the assistance tray body to be fed into the pill containing portions of the disk-type tray for manual distribution at the same time.

### BACKGROUND OF THE INVENTION

The present invention relates to an assistance tray for manual distribution which is used in a medicine sharing and packing device designed to automatically pack pills contained in a plurality of tablet cassettes automatically controlled and ones manually distributed to a disk-type tray for manual distribution dose by dose, and more particularly, an assistance tray for manual distribution which is designed to exactly distribute pills manually distributed, facilitate seeing the distributed pills, and quickly supply them to a medicine sharing and packing device.

In general, many kinds of pills are used to treat various diseases, and a plurality of different pills are prescribed mixedly due to complexity of a disease. As the development of technology will bring about the development of more medicines in the future, in addition to tablet cassettes mounted in a limited space disk-type trays for manual distribution are needed.

For conventional medicine sharing and packing devices, a plurality of tablet cassettes containing various pills are arranged, and medicine is packed dose by dose through control of the table cassettes. Since there are difficulties in containing more kinds of medicines being developed continuously into tablets cassettes, rearranging the cassettes, and supplying and packing pills prescribed to use half of each pill, a tray for manual distribution is additionally mounted on a medicine sharing and packing device.

A conventional tray for manual distribution is of disk type with a plurality of spaces for containing pills on the rim portion of its upper surface, in which half of a pill or pills which cannot be contained in tablet cassettes and are difficult to supply and pack automatically are distributed manually.

Once a pharmacist distributes pills, which are to be supplied manually out of prescribed ones, to a tray for manual distribution, and sees pills distributed to the tray, pills contained in tablet cassettes and ones distributed to the tray are supplied and packed together dose by dose by actuating the medicine sharing and packing device.

However, there is a disadvantage that for a conventional tray for manual distribution, packing remains stopped while pills are distributed to the tray and it takes much time to distribute and pack pills according to prescription, since pills are supplied from the tablet cassettes and tray after they are distributed manually to the tray.

Therefore, a doctor or pharmacist can reduce the whole packing time by continuously performing control of tablet cassettes and packing work while continuously distributing pills to the tray manually.

However, there is another disadvantage that since pills may be distributed incorrectly when a doctor or pharmacist continuously distributes pills to the tray, wrong packing of pills may occur.

### SUMMARY OF THE INVENTION

The present invention is contrived to overcome the conventional disadvantages described above. Therefore, it is an object of the present invention to provide an assistance tray for manual distribution which is designed to exactly distribute pills manually distributed, facilitate seeing the distributed pills, and quickly supply them to a medicine sharing and packing device.

To achieve the above-described object, an assistance tray for manual distribution used in medicine sharing and packing device with a disk-type tray for manual distribution of pills mounted in the front side comprises largely an assistance tray body at the rim portion of which a plurality of auxiliary pill containing portions as many as a plurality of pill containing portions formed at the rim of the upper surface of a disk-type tray for manual distribution are formed and on both sides of which handle portions are formed in the perforated state, and an opening/closing plate which is mounted on the lower surface of the assistance tray body so as to be rotated, at the rim portion of which holes as many as the auxiliary pill containing portions of the assistance tray body are formed, and on one side of which a control handle portion is formed in the protruding state, thereby opening the bottom of the auxiliary pill containing portions of the assistance tray body and accordingly enabling pills distributed to each auxiliary pill containing portion of the assistance tray body to be fed into the pill containing portions of the disk-type tray for manual distribution at the same time.

### BRIEF DESCRIPTION OF THE DRAWINGS

FIG. 1 is a perspective view showing a medicine sharing and packing device to which an assistance tray for manual distribution according to the present invention applies;

FIG. 2 is a plan view of an assistance tray for manual distribution used in medicine sharing and packing device according to the present invention;

FIG. 3 is a bottom view of an assistance tray for manual distribution used in medicine sharing and packing device according to the present invention;

FIG. 4 is a cross-sectional view taken along line A-A of FIG. 3;

FIG. 5 is a cross-sectional view taken along line B-B of FIG. 3; and

FIG. 6 is a view showing layered assistance trays for manual distribution used in medicine sharing and packing device according to the present invention.

### DETAILED DESCRIPTION OF THE PREFERRED EMBODIMENTS

With reference to the accompanying drawings, the present invention will now be described.

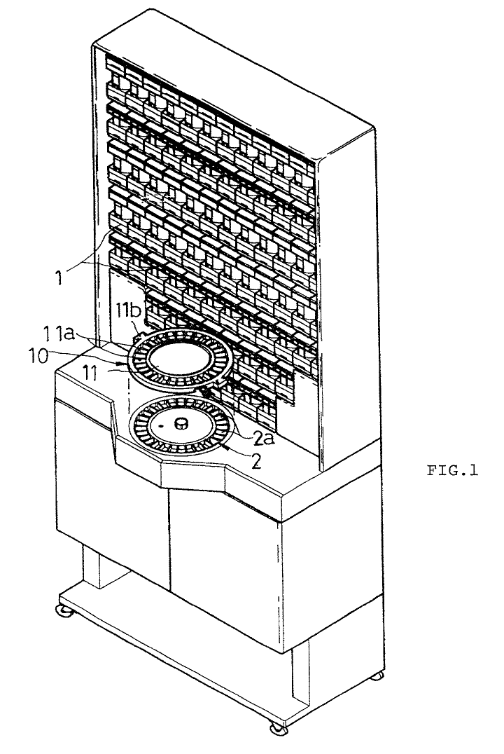

FIG. 1 shows a medicine sharing and packing device to which an assistance tray for manual distribution according to the present invention applies. The medicine sharing and packing device, like conventional ones, is designed to arrange a plurality of tablet cassettes(1) containing pills and pack medicine dose by dose through control of the tablet cassettes 1. A disk-type tray 2 for manual distribution, which can manually distribute half of a pill or pills which cannot be contained in tablet cassettes 1 and therefore packed automatically, is mounted on the front side of the medicine sharing and packing device, thereby allowing pills contained in the tablet cassettes 1 and ones contained in the tray 2 for manual distribution to be packed together dose by dose.

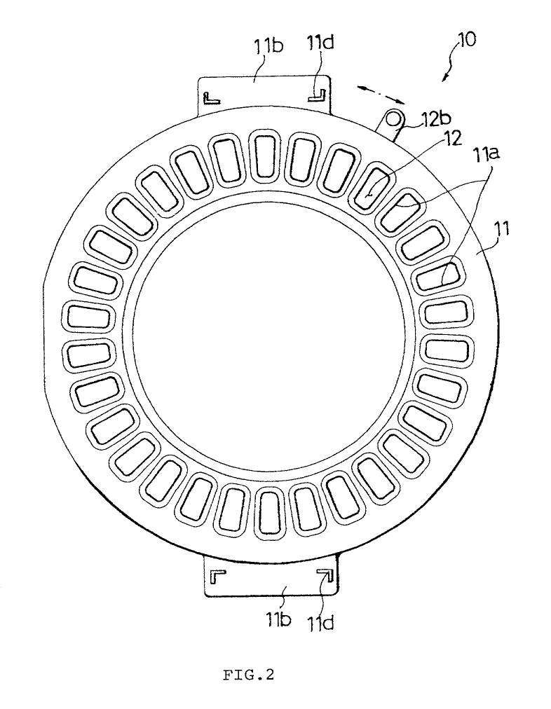

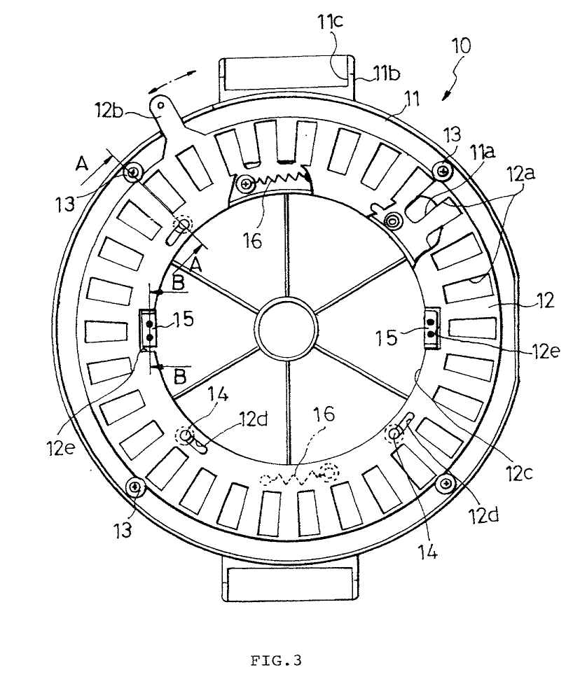

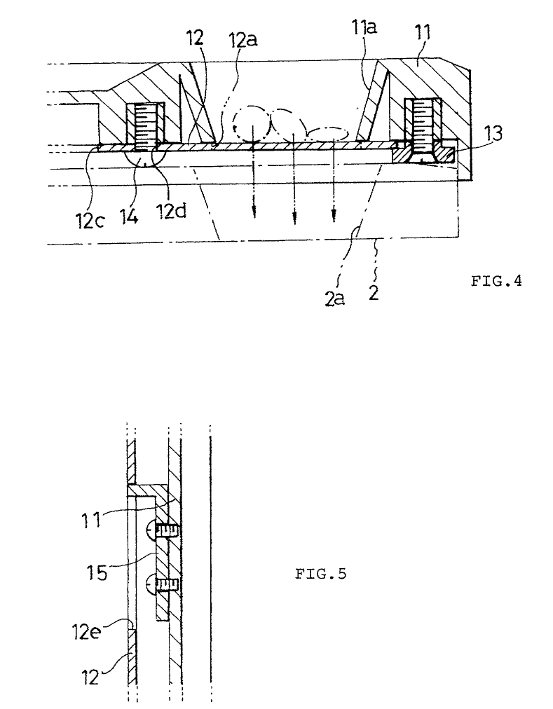

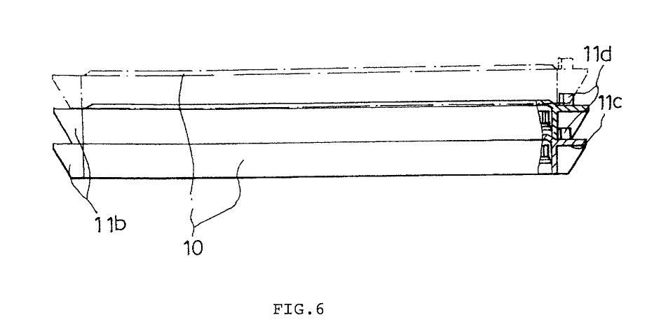

An assistance tray 10 according to the present invention, which is designed to put pills, which are distributed beforehand, into the tray 2 for manual distribution of the medicine sharing and packing device at a time, is so structured that, as illustrated in FIGS. 2, 3, 4 and 5, an opening/closing plate 12 is mounted on the lower surface of an assistance tray body 11 having a plurality of auxiliary pill containing portions so as to be rotated, thereby allowing the auxiliary pill containing portions of the assistance tray body 11 is opened and closed by the opening and closing plate 12.

That is, the assistance tray body 11 has a plurality of the auxiliary pill containing portions 11a in the perforated state at its rim portion as many as a plurality of the pill containing portions 1a formed at the rim portion of the upper surface of the disk-type tray 2 for manual distribution, and handle portions 11b on both sides.

Further, as illustrated in FIG. 6, two projections 11d are formed on both sides of the upper surface of the handle portions 11b of the assistance tray body 11, which fit onto grooves 11c formed on the lower parts of the handle portions 11b, thereby allows a plurality of the assistance tray bodies to be placed in layers well.

The opening/closing plate 12 is mounted on the lower surface of the assistance tray body 11 so as to be rotated, and has holes 12a at its rim portion as many as the auxiliary pill containing portions 11a of the assistance tray body 11 and a control handle portion 12b on one side in the protruding state, thereby opening the bottom of the auxiliary pill containing portions 11a of the assistance tray body 11 and accordingly enabling pills distributed to each auxiliary pill containing portion 11a of the assistance tray body 11 to be fed into the pill containing portions 2a of the disk-type tray 2 for manual distribution at the same time.

On the other hand, it is desirable that to facilitate the rotation of the opening/closing plate 12, a plurality of supporting rollers 13, which support the circumferential surface of the opening/closing plate 12, be mounted in the spaced state at the rim portion of the assistance tray body 11, an inside diameter portion 12c be formed at the central portion of the opening/closing plate 12, a plurality of circular slots 12d be formed in the spaced state near the inside diameter portion 12c, and screws 14 to be inserted into the slots 12d is fastened to the assistance tray body 11.

Further it is desirable that stoppers 15 for stopping the opening/closing plate 12 at a specific rotary angle by supporting one side of two grooves 12e formed at the inside diameter portion 12c of the opening/closing plate 12 be fixed to the assistance tray body 11, in order to maintain a uniform rotary angle of the opening/closing plate 12.

To return the opening/closing plate 12 to its initial state, two elastic members 16 for rotating the opening/closing plate 12 in the direction of closing the auxiliary pill containing portions 12 of the assistance tray body 11 are connected between the assistance tray body 11 and the opening/closing plate 12.

An assistance try for manual distribution used in medicine sharing and packing device according to the present invention works as follows.

If pills not contained in tablet cassettes 1 or half of pills are prescribed, a pharmacist distributes them manually to auxiliary pill containing portions 11a of an assistance tray body 11 of an assistance tray 10.

Then, the pharmacist matches the assistance tray body 11 with a tray 2 for manual distribution by gripping and lifting handles 11b of the assistance tray body 11, and rotates an opening/closing plate 12 by means of a control handle portion 12b to match holes 12a of the opening/closing plate 12 with the auxiliary pill containing portions 11a of the assistance tray body 11.

Then, pills contained in the auxiliary pill containing portions 11a of the assistance tray body 11 are dropped into pill containing portions 2a of the tray 1, and the opening/closing plate 12 is returned to the initial state by elastic members 16 and closes the auxiliary pill containing portions 11a of the assistance tray body 11 by releasing the control handle portion 12b of the opening/closing plate 12.

After the assistance tray 10 is spaced from the tray 1, pills in the pill containing portions 2a of the tray are packed dose by dose with pills dropped from tablet cassettes 1 by the operation of the medicine sharing and packing device.

Of course, it is desirable that a plurality of assistance trays 10 be used, thereby facilitating exact check of pills distributed in advance according to prescription and quick standby of the assistance tray 10 before pills distributed to the tray 2 are packed, so that quick packing can be realized.

As illustrated in FIG. 6, it is possible to distribute pills another assistance tray 10 after distributing them into one assistance tray 10, and to place many assistance trays 10, to which pills are distributed, in layers.

Accordingly, if the assistance trays 10 in layers are used, pills distributed to the assistance trays 10 can be supplied more quickly in the state of having been distributed to the tray 2.

As discussed above, an assistance tray for manual distribution allows pills distributed separately to be quickly supplied to a tray for manual distribution of a medicine sharing and packing device by means of a control handle of an opening/closing plate. Therefore, pills distributed manually can be distributed quickly and checked easily. The use of additional assistance trays enables pills distributed manually to be supplied quickly to a medicine sharing and packing device.

What is claimed is:

1. An assistance tray for manual distribution used in medicine sharing and packing device with a disk-type tray for manual distribution of pills mounted in the front side comprising largely an assistance tray body 11 at the rim portion of which a plurality of auxiliary pill containing portions 11a as many as a plurality of pill containing portions 2a formed at the rim of the upper surface of a disk-type tray 2 for manual distribution are formed and on both sides of which handle portions 11b are formed in the perforated state, and an opening/closing plate 12 which is mounted on the lower surface of said assistance tray body 11 so as to be rotated, at the rim portion of which holes 12a as many as said auxiliary pill containing portions 11a of said assistance tray body 11 are formed, and on one side of which a control handle portion 12b is formed in the protruding state, thereby opening the bottom of said auxiliary pill containing portions 11a of said assistance tray body 11 and accordingly enabling pills distributed to each auxiliary pill containing portion 11a of said assistance tray body 11 to be fed into said pill containing portions 2a of said disk-type tray 2 for manual distribution at the same time.

2. An assistance tray for manual distribution used in medicine sharing and packing device according to claim 1, wherein a plurality of supporting rollers 13, which support the circumferential surface of said opening/closing plate 12, are mounted in the spaced state at the rim portion of said assistance tray body 11, an inside diameter portion 12c is formed at the central portion of said opening/closing plate 12, a plurality of circular slots 12d are formed in the spaced state near said inside diameter portion 12c, screws 14 to be inserted into said slots 12d are fastened to said assistance tray body 11 to support said opening/closing plate 12, stoppers 15 for determining the rotary angle of said opening/closing plate 12 by supporting one side of two grooves 12e formed at said inside diameter portion 12c of said opening/closing plate 12 are fixed to said assistance tray body 11, and two elastic members 16 for rotating said opening/closing plate 12 in the direction of closing said auxiliary pill containing portions 12 of said assistance tray body 11 are connected between the assistance tray body 11 and the opening/closing plate 12.
